(19) United States
(12) Patent Application Publication
(10) Pub. No.: US 2018/0274918 A1
(43) Pub. Date: Sep. 27, 2018

(54) THREE-DIMENSIONAL MEASUREMENT APPARATUS, NON-TRANSITORY COMPUTER READABLE MEDIUM, AND THREE-DIMENSIONAL MEASUREMENT SYSTEM

(71) Applicant: FUJI XEROX CO., LTD., Tokyo (JP)

(72) Inventor: Ryo KUKIMIYA, Kanagawa (JP)

(73) Assignee: FUJI XEROX CO., LTD., Tokyo (JP)

(21) Appl. No.: 15/685,597

(22) Filed: Aug. 24, 2017

(30) Foreign Application Priority Data
Mar. 23, 2017 (JP) 2017-057622

(51) Int. Cl. G01C 3/20; G01C 3/30

(52) U.S. Cl. CPC G01C 3/20; G01C 3/30

(57) ABSTRACT

A three-dimensional measurement apparatus includes an image obtainer, a search unit, and a distance calculator. The image obtainer obtains, from an imaging device that creates a distance image where a distance value representing an imaging distance at each position within an imaging angle of view is given to a pixel at the position, the distance image. The search unit searches the distance image for a specific pixel whose distance value is a predetermined specific value. The distance calculator calculates an imaging distance of the specific pixel by referring to pixels positioned across the specific pixel.

### CROSS-REFERENCE TO RELATED APPLICATIONS

This application is based on and claims priority under 35 USC 119 from Japanese Patent Application No. 2017-057622 filed Mar. 23, 2017.

### BACKGROUND

### (i) Technical Field

The present invention relates to a three-dimensional measurement apparatus, a non-transitory computer readable medium, and a three-dimensional measurement system.

### (ii) Related Art

There is known a three-dimensional measurement system that captures an image of a person of interest (or an object of interest), whose portions such as the elbows and knees are attached with markers, using multiple imaging devices to three-dimensionally measure the spatial positions of these portions. Such a three-dimensional measurement system is large-scale and costly, and takes much labor in the measurement.

As a three-dimensional measurement system used in game machines or the like, there is known a three-dimensional measurement system using the Time of Flight (ToF) measurement method. An apparatus based on the ToF method has a simple structure where an optical (infrared) irradiation device and an imaging device are combined. For each point within the imaging angle of view, a distance from an object at that point is easily detectable. However, the position accuracy is low because portions such as the elbows of a person of interest are identified using image analysis.

### SUMMARY

According to an aspect of the invention, there is provided a three-dimensional measurement apparatus including an image obtainer, a search unit, and a distance calculator. The image obtainer obtains, from an imaging device that creates a distance image where a distance value representing an imaging distance at each position within an imaging angle of view is given to a pixel at the position, the distance image. The search unit searches the distance image for a specific pixel whose distance value is a predetermined specific value. The distance calculator calculates an imaging distance of the specific pixel by referring to pixels positioned across the specific pixel.

### BRIEF DESCRIPTION OF THE DRAWINGS

Exemplary embodiments of the present invention will be described in detail based on the following figures, wherein:

FIG. 1 is a schematic configuration diagram illustrating a three-dimensional measurement system according to a first exemplary embodiment of the present invention;

FIG. 2 is a functional block diagram illustrating a functional structure of the three-dimensional measurement system;

FIG. 3 is a flowchart illustrating a three-dimensional measurement process performed by the three-dimensional measurement system;

FIG. 4 is a diagram illustrating an image of different items of data obtained in the three-dimensional measurement;

FIG. 5 is a diagram illustrating a method of calculating an imaging distance;

FIG. 6 is a diagram illustrating exemplary marker shapes;

FIG. 7 is a schematic configuration diagram illustrating a three-dimensional measurement system according to a second exemplary embodiment of the present invention; and

FIG. 8 is a functional block diagram illustrating a functional structure of the three-dimensional measurement system according to the second exemplary embodiment.

### DETAILED DESCRIPTION

Hereinafter, exemplary embodiments of the present invention will be described with reference to the drawings.

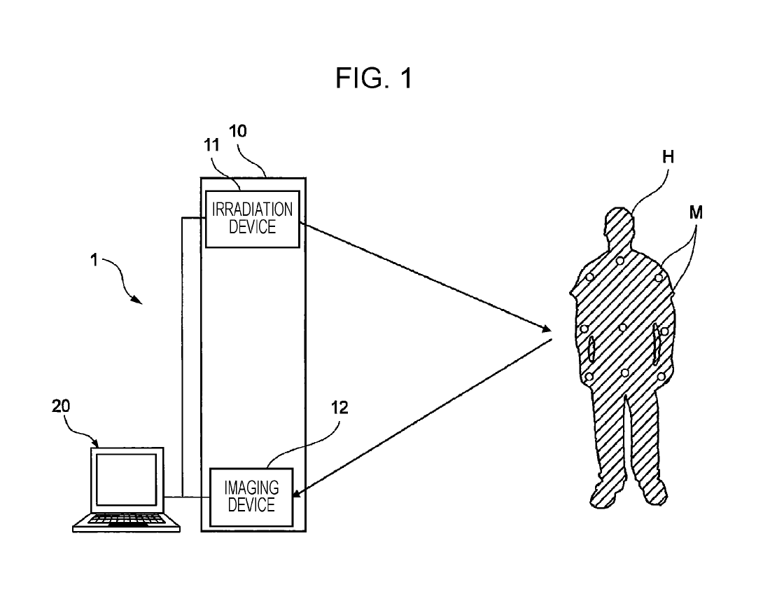

FIG. 1 is a schematic configuration diagram illustrating a three-dimensional measurement system according to a first exemplary embodiment of the present invention.

A three-dimensional measurement system 1 illustrated in FIG. 1 is a system that measures the three-dimensional position of an object H of interest to be measured, such as a person (hereinafter such an object will be referred to as an “object of interest”). It is assumed that, among portions of the object H of interest, portions whose positions are particularly desired to be specified, such as joint portions, are attached with markers M, which will be described in detail later. The above-described three-dimensional measurement system 1 is used for, for example, monitoring the position and movement of workers at a work site, such as a factory, for safety management.

The three-dimensional measurement system 1 includes an optical apparatus 10 including an irradiation device 11 and an imaging device 12, and a control computer 20 that controls the optical apparatus 10 and analyzes data obtained by the optical apparatus 10.

The irradiation device 11 irradiates the entire space where there is the object H of interest with light (such as infrared rays by way of example here). The imaging device 12 receives, at a position somewhat distant from the irradiation device 11, light reflected from the object H of interest and from other objects, and captures an image within the imaging angle of view. In this image capturing, the imaging device 12 obtains an imaging distance that indicates the distance from the imaging device 12 to the object using the so-called ToF method for each point within the imaging angle of view, and creates a distance image where each pixel is given a distance value, which is the value of the imaging distance. As a method of creating a distance image, a method other than the ToF method, such as a parallax method or a dot-pattern projection method, is adoptable. However, in the first exemplary embodiment, the following description assumes that the ToF method is used.

The control computer 20 is realized by, for example, a personal computer and a program. The control computer 20 controls the cooperation between the irradiation device 11 and the imaging device 12 using the ToF method, functions as a three-dimensional measurement apparatus according to an exemplary embodiment of the present invention, and calculates the three-dimensional positions of the markers M attached to the object H of interest from a distance image.

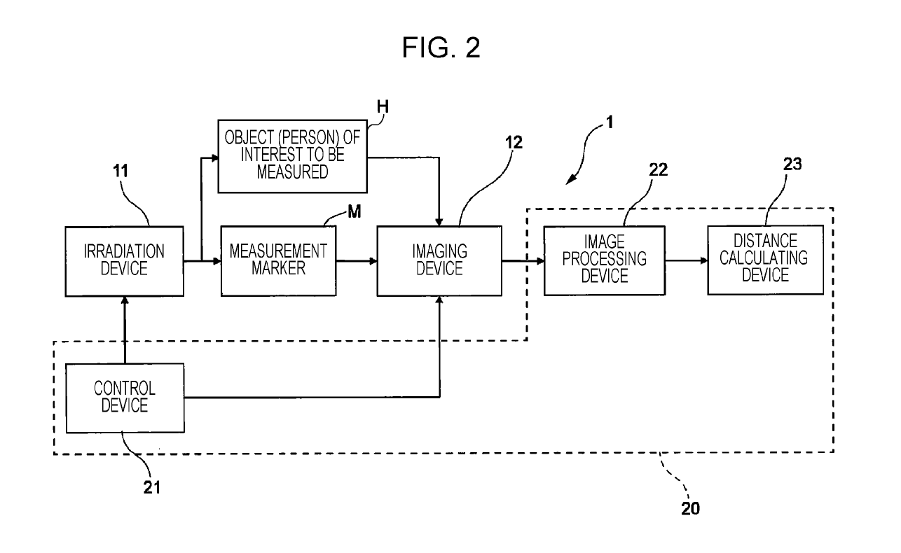

FIG. 2 is a functional block diagram illustrating a functional structure of the three-dimensional measurement system.

As described above, the three-dimensional measurement system 1 irradiates the object H of interest and the markers M with light from the irradiation device 11.

The imaging device 12 captures an image within the imaging angle of view where there are the object H of interest and the markers M, thereby creating a distance image described above. In creation of a distance image, the ToF control is executed by a control device 21 serving as a function of the above-described control computer 20.

The distance image created by the imaging device 12 is obtained by an image processing device 22 serving as a function of the control computer 20, thereby obtaining an area of the object H of interest which is present within the imaging angle of view. The image processing device 22 corresponds to an example of a combination of an image obtainer and an area determiner according to an exemplary embodiment of the present invention.

Furthermore, a distance calculating device 23 serving as a function of the control computer 20 searches for the markers M within the area of the object H of interest, thereby calculating an imaging distance of each marker M. The distance calculating device 23 corresponds to an example of a combination of a search unit and a distance calculator according to an exemplary embodiment of the present invention.

Hereinafter, a three-dimensional measurement process performed by the three-dimensional measurement system 1 will be described.

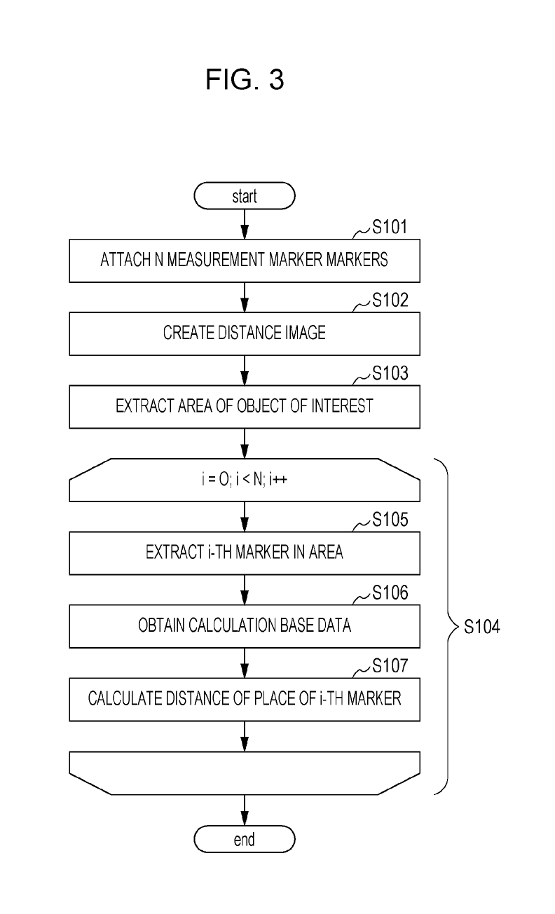

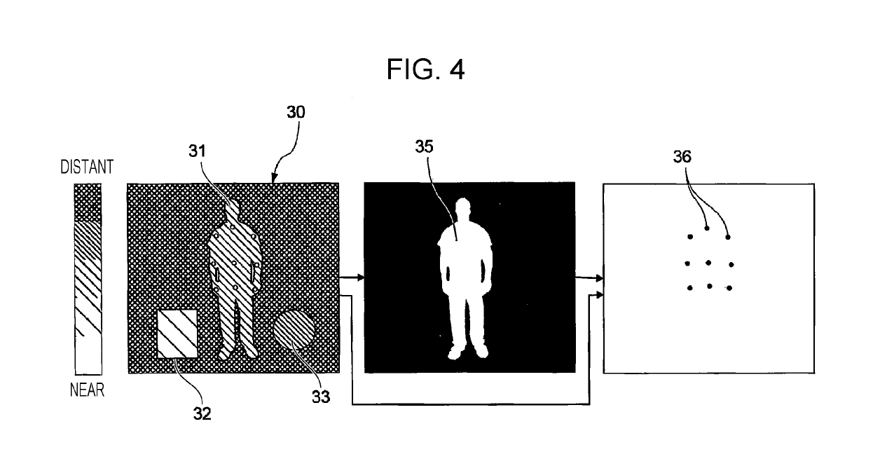

FIG. 3 is a flowchart illustrating a three-dimensional measurement process performed by the three-dimensional measurement system 1. FIG. 4 is a diagram illustrating an image of different items of data obtained in the three-dimensional measurement.

Steps S103 to S107 of the flowchart illustrated in FIG. 3 represents an example of a three-dimensional measurement program according to an exemplary embodiment of the present invention. By executing, with the use of an information processing apparatus such as a personal computer, an operation represented in steps S103 to S107 of FIG. 3, the information processing apparatus operates as a three-dimensional measurement apparatus according to an exemplary embodiment of the present invention.

When the three-dimensional measurement system 1 starts three-dimensional measurement, in step S101, N markers M are attached to an object H of interest. In step S102, under control of the control device 21, irradiation by the irradiation device 11 and image capturing by the imaging device 12 are performed to create a distance image.

FIG. 4 illustrates an example of a distance image 30. The distance image 30 generally includes, besides an image portion 31 of the object H of interest, image portions 32 and 33 of other objects.

The above-mentioned distance image 30 is obtained by the image processing device 22 in step S103, and the image processing device 22 extracts an image area 35, which corresponds to the image portion 31 of the object H of interest, from the distance image 30 (see FIG. 4). Step S103 corresponds to an operation serving as an example of an image obtainer and an area determiner according to an exemplary embodiment of the present invention. A specific method of extracting the image area 35 includes, for example, a method of extracting an area of, among the individual pixels of the distance image 30, a pixel that has a distance value belonging to a specific distance range as the image area 35 of the object H of interest. Alternatively, for example, the image processing device 22 may obtain the contour of the object H of interest by performing edge detection which extracts a portion where the luminance value changes relatively greatly, compared with surrounding pixels, in the case where each pixel's distance value is used as the luminance value, and may extract an area surrounded by the contour as the image area 35 of the object H of interest. When an image area of an object H of interest is determined by obtaining a contour, the image area of the object H of interest is identified accurately, compared with the case where the area is determined simply by using the distance.

Once the image area 35 of the object H of interest is extracted, the process proceeds next to loop processing in step S104, and the process from steps S105 to S107, which will be described later, is repeated for the N markers M.

Firstly in step S105, the above-mentioned distance calculating device 23 searches the extracted image area 35 for places 36 of the markers M. As the markers M attached to the object H of interest, for example, markers M formed of a retroreflective material are used. The markers M have characteristics that the markers M reflect much of light emitted from the above-mentioned irradiation device 11 toward the irradiation device 11 side, but do not reflect much light toward the imaging device 12 side. Therefore, it is difficult for the imaging device 12 to receive light reflected from the places 36 of the markers M, and an error value is given as a distance measurement value. The distance calculating device 23 searches for the places of pixels where such error values are given as the places 36 corresponding to the markers M. Step S105 corresponds to an operation serving as an example of a search unit according to an exemplary embodiment of the present invention. By searching for the places 36 of the markers M, the positions of the markers M within the imaging angle of view are specified.

Since the above-mentioned search method is used in step S105, as the markers M attached to the object H of interest, besides the markers M formed of a retroreflective material as described above, for example, markers M formed of a material whose reflectivity is particularly low for irradiation light from the irradiation device 11 may be used.

Next, the distance calculating device 23 obtains distance values for imaging distance calculation for each of the places 36 of the markers M, found in the above search, in step S106, and calculates an imaging distance in step S107. Step S107 corresponds to an operation serving as an example of a distance calculator according to an exemplary embodiment of the present invention.

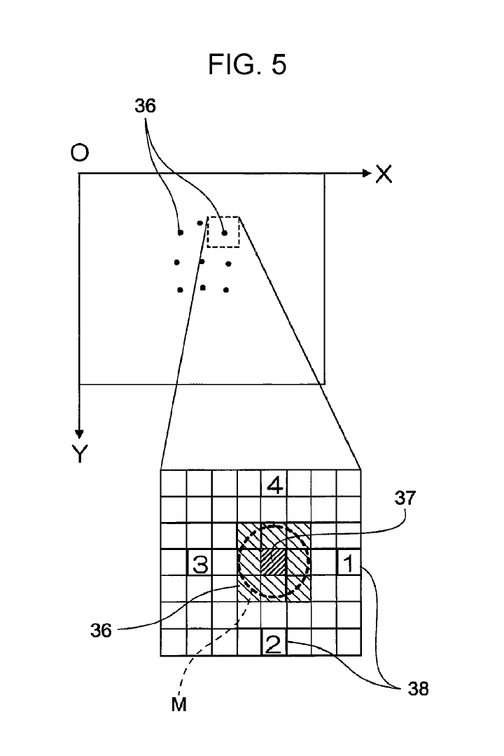

FIG. 5 is a diagram illustrating a method of calculating an imaging distance.

The places 36 of the markers M, found in the search conducted by the distance calculating device 23, are the places 36 of dots, such as those illustrated in FIG. 5, for example. In the enlarged view, for example, one place 36 that has a total of nine pixels (three times three) is illustrated. Such places 36 correspond to the markers M, and the distance values of pixels included in each of the places 36 are error values.

The distance calculating device 23 selects, for example, a pixel 37 at the center of each place 36 (hereinafter referred to as a center pixel 37) as the representative position of a corresponding one of the markers M, and calculates an imaging distance. Although imaging distances may be calculated for all the pixels included in each place 36 corresponding to each marker M, for convenience of explanation, the description assumes that the center pixel 37 is the place where an imaging distance is calculated.

The distance calculating device 23 obtains, as base data for calculating the imaging distance, for example, distance values of surrounding pixels 38, which surround the center pixel 37 vertically and horizontally at an equal distance. In FIG. 5, the numerals “1”, “2”, “3”, and “4” are indicated in the four surrounding pixels 38. These numerals are for distinguishing the surrounding pixels 38 and are not the distance values given to the surrounding pixels 38.

The distance calculating device 23 obtains the distance values of, among the surrounding pixels 38, surrounding pixels 38 positioned in the image area 35 of the object H of interest as base data for calculating the imaging distance of the center pixel 37 in step S106 of FIG. 3. Among the four surrounding pixels 38 illustrated in FIG. 4, if the surrounding pixel 38 given the numeral “1” is positioned outside the image area 35 of the object H of interest, the distance value of this pixel is highly likely to be greatly different from the true imaging distance of the marker M; thus, the distance value of this pixel is excluded from base data. In step S107 of FIG. 3, the distance calculating device 23 calculates the imaging distance of the center pixel 37 using the distance values of the remaining three surrounding pixels 38. In this manner, the distance value of a pixel outside the image area 35 of the object H of interest is excluded, which improves the accuracy of calculating the imaging distance. By having the imaging distance of the center pixel 37 representing each of the places 36 of the markers M calculated, in conjunction with determination of the positions of the places 36 of the markers M within the imaging angle of view, the three-dimensional positions of the markers M are measured.

In a specific method of calculating the imaging distance using the distance values of the three surrounding pixels 38, for example, the average of the distance values of the three surrounding pixels 38 is calculated as the imaging distance of the center pixel 37. With the use of the distance values of multiple surrounding pixels 38 among the surrounding pixels 38, an imaging distance close to the true imaging distance of the marker M is calculated.

In another specific method of calculating the imaging distance, for example, among the three surrounding pixels 38, the average of the distance values of two surrounding pixels 38 given the numeral “2” and the numeral “4”, which are positioned across the center pixel 37, may be calculated as the imaging distance of the center pixel 37. With the use of the distance values of pixels across the center pixel 37, the imaging distance is calculated accurately even from the distance values of a few pixels.

The process from steps S105 to S107 is repeated for the number of the markers M, or, if a new marker M is not found before the number of repetitions reaches N times, the loop processing in step S104 ends, and the three-dimensional measurement process also ends.

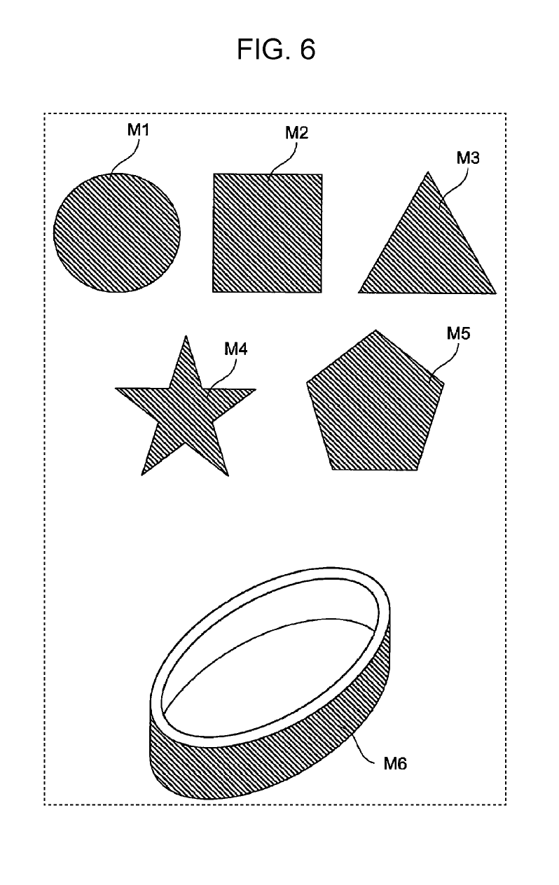

Next, the shape of the markers M will be described. FIG. 6 is a diagram illustrating exemplary marker shapes.

Because it is only necessary for markers attached to an object of interest to be made of a material that produces a specific value such as an error value at the time of forming a distance image, the markers are realized with a simple one-member structure. Therefore, the degree of freedom in the shape of markers is high, and markers with various shapes such as a round marker M1, a rectangular marker M2, a triangular marker M3, a star-shaped marker M4, and a pentagonal marker M5, are conceivable. Furthermore, a ring-shaped marker M6 is also conceivable. The ring-shaped marker M6 may be used by being wrapped around a wrist or an elbow, which prevents the marker M6 from being hidden, unlike the case where the marker M6 is hidden due to the movement or posture of an arm or the case where the marker M6 is hidden behind the clothes.

Next, a second exemplary embodiment different from the above-described first exemplary embodiment will be described.

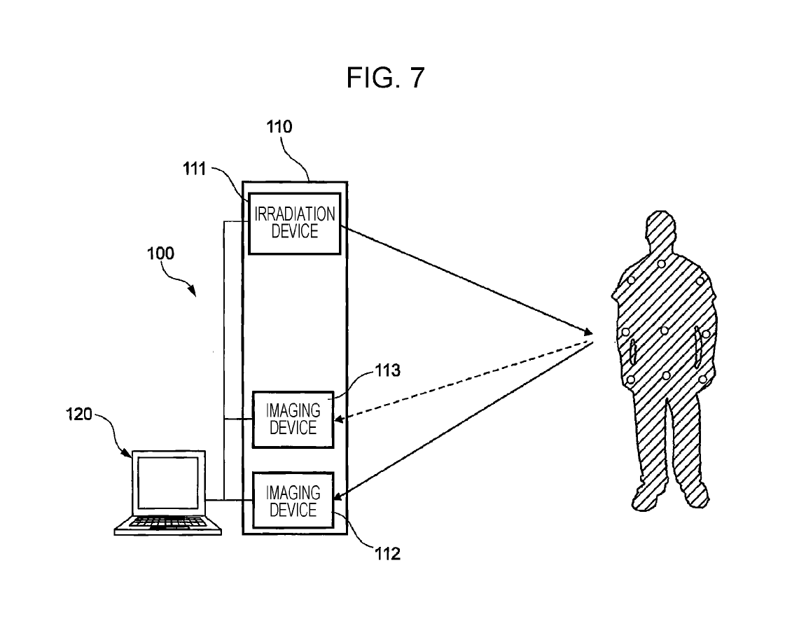

FIG. 7 is a schematic configuration diagram illustrating a three-dimensional measurement system according to the second exemplary embodiment of the present invention.

A three-dimensional measurement system 100 illustrated in FIG. 7 includes an optical apparatus 110 and a control computer 120.

The optical apparatus 110 includes an irradiation device 111, a first imaging device 112, and a second imaging device 113. The irradiation device 111 and the first imaging device 112 are equivalents of the irradiation device 11 and the imaging device 12 illustrated in FIG. 1, and create a distance image using the ToF method, for example.

The second imaging device 113 creates a captured image such as a color image by capturing an image of an object H of interest using, for example, light (such as visible light) with a different wavelength from the wavelength of irradiation light of the irradiation device 111. The captured image created as above is obtained by the control computer 120.

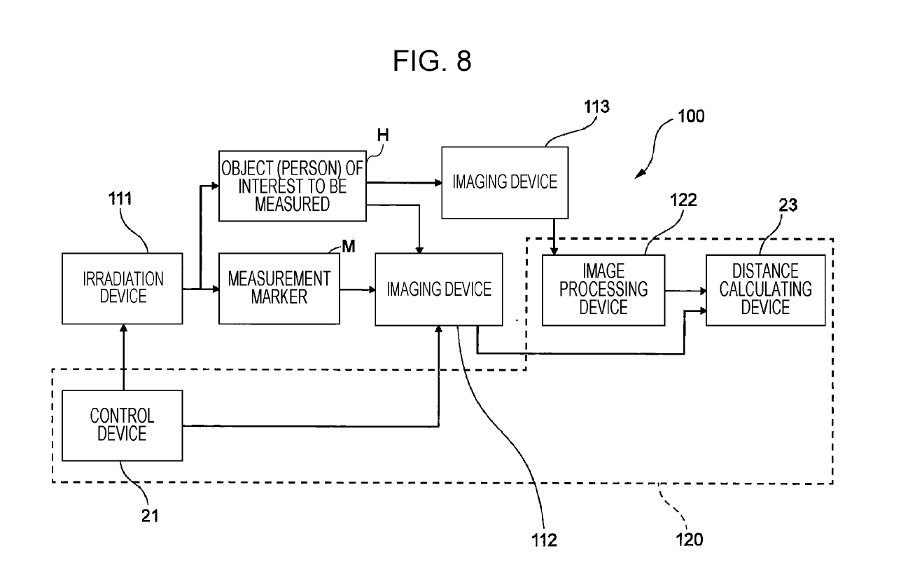

FIG. 8 is a functional block diagram illustrating a functional structure of the three-dimensional measurement system 100 according to the second exemplary embodiment.

Like the three-dimensional measurement system 1 according to the first exemplary embodiment, the three-dimensional measurement system 100 according to the second exemplary embodiment also irradiates the object H of interest and the markers M with light from the irradiation device 111. A distance image is created by image capturing performed by the first imaging device 112 using light with the same wavelength as irradiation light, and a captured image such as a color image is created by image capturing performed by the second imaging device 113 using light with a different wavelength from irradiation light.

The control computer 120 according to the second exemplary embodiment includes functions that are the control device 21, an image processing device 122, and the distance calculating device 23, like the control computer 20 illustrated in FIG. 2.

The distance image created by the first imaging device 112 is obtained by the distance calculating device 23 serving as a function included in the control computer 120 in the case of the second exemplary embodiment. In the second exemplary embodiment, the distance calculating device 23 corresponds to an example of an image obtainer according to an exemplary embodiment of the present invention.

Meanwhile, the captured image created by the second imaging device 113 is obtained by the image processing device 122 serving as a function of the control computer 120, and an image area of the object H of interest, which is present within the imaging angle of view, is obtained by conducting image analysis of the captured image. In the second exemplary embodiment, the image processing device 122 corresponds to an example of an area determiner according to an exemplary embodiment of the present invention.

As a method of determining an image area of the object H of interest with the use of the image processing device 122, an arbitrary existing technology is adoptable, such as a method of determining the contour of the area by conducting edge analysis, or a method of determining the area by conducting color analysis of clothes, skin, or hair. With the use of image analysis of the captured image, which is different from the distance image, the area of the object H of interest is obtained accurately.

Using the image area of the object H of interest, determined by the image processing device 122, and the distance image obtained from the first imaging device 112, the distance calculating device 23 calculates the imaging distance of each of the places of markers by performing a process that is the same as or similar to step S104 (steps S105 to S107) of FIG. 3.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A three-dimensional measurement apparatus comprising:
an image obtainer that obtains, from an imaging device that creates a distance image where a distance value representing an imaging distance at each position within an imaging angle of view is given to a pixel at the position, the distance image;
a search unit that searches the distance image for a specific pixel whose distance value is a predetermined specific value; and
a distance calculator that calculates an imaging distance of the specific pixel by referring to pixels positioned across the specific pixel.

2. The three-dimensional measurement apparatus according to claim 1, further comprising:
an area determiner that determines an area of interest where there is a predetermined object of interest, among one or more objects in the distance image, wherein:
the search unit searches the area of interest for the specific pixel.

3. The three-dimensional measurement apparatus according to claim 2, wherein the distance calculator calculates an imaging distance of the specific pixel by referring to pixels positioned across the specific pixel and using distance values of, among the referenced pixels, pixels positioned within the area of interest.

4. The three-dimensional measurement apparatus according to claim 2, wherein the area determiner determines, as the area of interest, an area of pixels with distance values included in a predetermined distance range.

5. The three-dimensional measurement apparatus according to claim 2, wherein the area determiner determines the area of interest on a basis of another captured image of the object of interest and the distance image.

6. The three-dimensional measurement apparatus according to claim 2, wherein the area determiner determines the area of interest by analyzing a contour of the object of interest.

7. The three-dimensional measurement apparatus according to claim 1, wherein the distance calculator calculates an imaging distance of the specific pixel by referring to three or more surrounding pixels positioned around the specific pixel.

8. The three-dimensional measurement apparatus according to claim 7, wherein the distance calculator calculates an imaging distance of the specific pixel by referring to the surrounding pixels and using distance values of a plurality of pixels among the surrounding pixels.

9. The three-dimensional measurement apparatus according to claim 1, wherein the search unit searches for, as the specific pixel, a pixel that has a failure value as a distance value, the failure value representing failure in measurement of the imaging distance.

10. A non-transitory computer readable medium storing a three-dimensional measurement program embedded in an information processing apparatus and causing the information processing program to execute a process, the process comprising:
obtaining, from an imaging device that creates a distance image where a distance value representing an imaging distance at each position within an imaging angle of view is given to a pixel at the position, the distance image;
searching the distance image for a specific pixel whose imaging distance value is a predetermined specific value; and
calculating an imaging distance of the specific pixel by referring to imaging distance values of pixels positioned across the specific pixel.

11. A three-dimensional measurement system comprising:
an imaging device that creates a distance image where a distance value representing an imaging distance at each position within an imaging angle of view is given to a pixel at the position;
an image obtainer that obtains the distance image from the imaging device;
a specific pixel search unit that searches the distance image for a specific pixel whose imaging distance value is a predetermined specific value; and
a distance calculator that calculates an imaging distance of the specific pixel by referring to imaging distance values of pixels positioned across the specific pixel.
